(19) United States
(12) Patent Application Publication
(10) Pub. No.: US 2016/0070296 A1
(43) Pub. Date: Mar. 10, 2016

(54) WEARABLE DEVICES

(71) Applicant: Applejack 199 L.P., Los Altos, CA (US)

(72) Inventors: Ann KOO, Los Altos, CA (US); Jack XU, Los Altos, CA (US)

(21) Appl. No.: 14/845,989

(22) Filed: Sep. 4, 2015

Related U.S. Application Data
(60) Provisional application No. 62/046,055, filed on Sep. 4, 2014.

(51) Int. Cl. G06F 1/16; H02J 7/35; H02J 7/00; H02J 7/02

(52) U.S. Cl. CPC G06F 1/163; H02J 7/025; H02J 7/35; H02J 7/0013

(57) ABSTRACT

A wearable device may include a flexible printed circuit board and a processing unit coupled with the flexible printed circuit board. The processing unit may include a display device. The wearable device may also include one or more battery blocks mounted on the flexible printed circuit board, the one or more battery blocks configured to supply power to the processing unit. The wearable device may further include an antenna mounted on the flexible printed circuit board and communicatively coupled with the processing unit.

### FIELD

The embodiments discussed in the present disclosure are related to wearable devices.

### SUMMARY

According to an aspect of an embodiment, a wearable device may include a flexible printed circuit board and a processing unit coupled with the flexible printed circuit board. The processing unit may include a display device. The wearable device may also include one or more battery blocks mounted on the flexible printed circuit board, the one or more battery blocks configured to supply power to the processing unit. The wearable device may further include an antenna mounted on the flexible printed circuit board and communicatively coupled with the processing unit.

The object and advantages of the implementations will be realized and achieved at least by the elements, features, and combinations particularly pointed out in the claims.

It is to be understood that both the foregoing general description and the following detailed description are given as examples and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A illustrates an example wearable device;

FIG. 1B illustrates another example wearable device;

FIG. 1C illustrates yet another example wearable device;

FIG. 1D illustrates yet another example wearable device;

FIG. 2 illustrates a block diagram of example battery blocks in a wearable device;

FIG. 3 illustrates an example communication system that includes a wearable device; and

FIG. 4 is a flow chart that illustrates an example method of providing alerts using a wearable device.

### DESCRIPTION OF EMBODIMENTS

Some embodiments described in the present disclosure may include wearable devices. Examples of a wearable device may include, but are not limited to, a watch band, a wrist band, a necklace band, an armband, an ankle band, a belt, a head band, a band or a strip that may be sewed on garments, and any other suitable wearable device that may be worn by a user. In some embodiments, the wearable device may include one or more of a flexible printed circuit board (PCB), an antenna, one or more battery blocks, one or more speakers, a microphone or an audio sensor, a universal serial bus (USB) connector, a processing unit, and any other suitable elements. In some embodiments, elements to be included in the wearable device may be customized based on user preferences. For example, a first user may customize a first wearable device to include a display without speakers while a second user may customize a second wearable device to include two speakers.

In some embodiments, the antenna may be mounted on the flexible PCB. In some embodiments, the antenna may include a flexible radio frequency (RF) antenna. The antenna may provide local area network (LAN) connectivity, Bluetooth connectivity, wireless fidelity (Wi-Fi) connectivity, near field connection (NFC) connectivity, Machine-to-Machine (M2M) connectivity, Device-to-Device (D2D) connectivity, mobile communications (GSM) connectivity, 3G connectivity, 4G connectivity, long-term evolution (LTE) connectivity, any other suitable communication capability, or any suitable combination thereof.

In some embodiments, the processing unit may be coupled with the flexible PCB. In some embodiments, the processing unit may include a display device (e.g., a touch screen), an integrated sensor (e.g., a sensor integrated from an accelerometer, a gyroscope, and a magnetometer), a processor, a memory, and any other suitable components. In some embodiments, the processing unit may be disposed in the middle of the wearable device. Alternatively, in some embodiments, the processing unit may be disposed on one end of the wearable device or on any portion of the wearable device.

In some embodiments, the one or more battery blocks may be mounted on the flexible PCB. The one or more battery blocks may be configured to supply power to the processing unit. In some embodiments, the one or more battery blocks may be coupled using one of a series connection and a parallel connection. In some embodiments, each of the battery blocks may include one or more battery layers. In some embodiments, the battery layers in a corresponding battery block may be coupled using one of a series connection and a parallel connection. In some embodiments, a battery layer may include one of a thin film rechargeable battery, a lithium battery, a sodium-ion battery, and any other suitable type of rechargeable batteries.

Embodiments of the present disclosure will be explained with reference to the accompanying drawings.

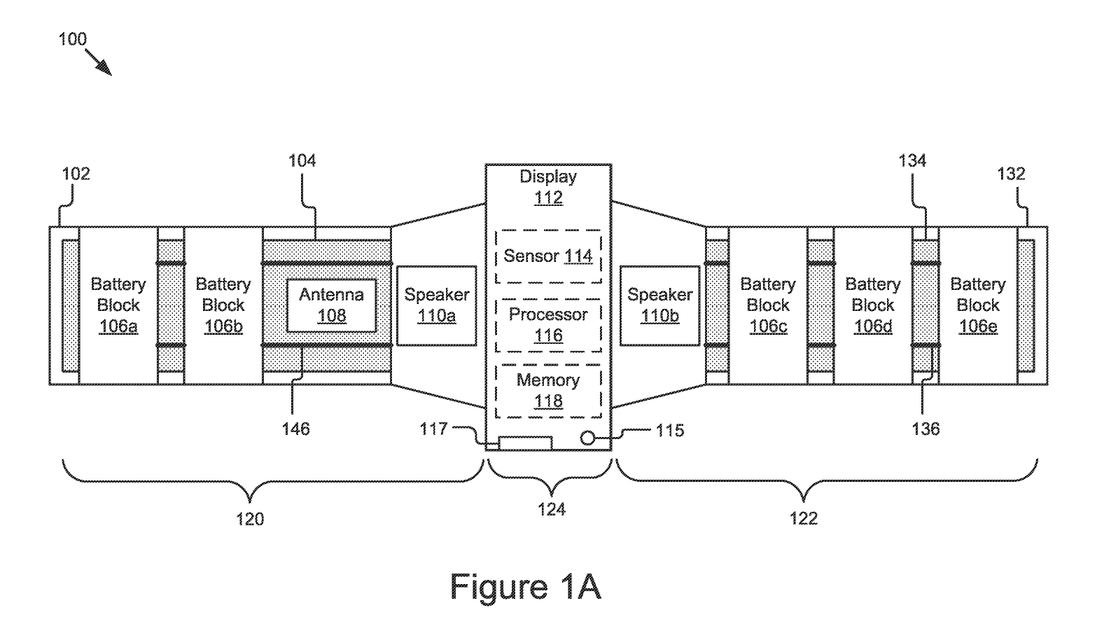

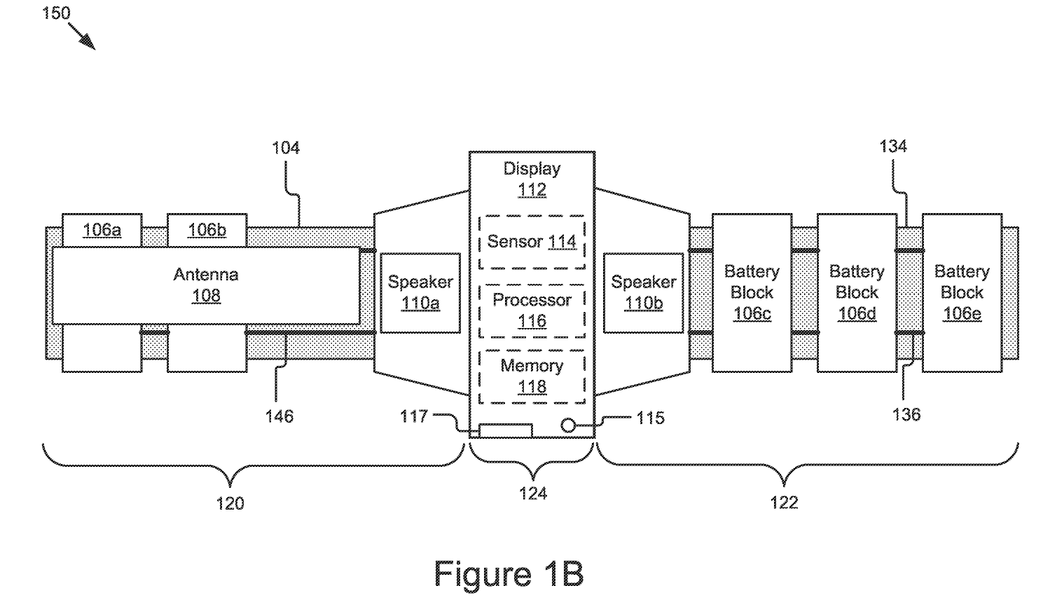

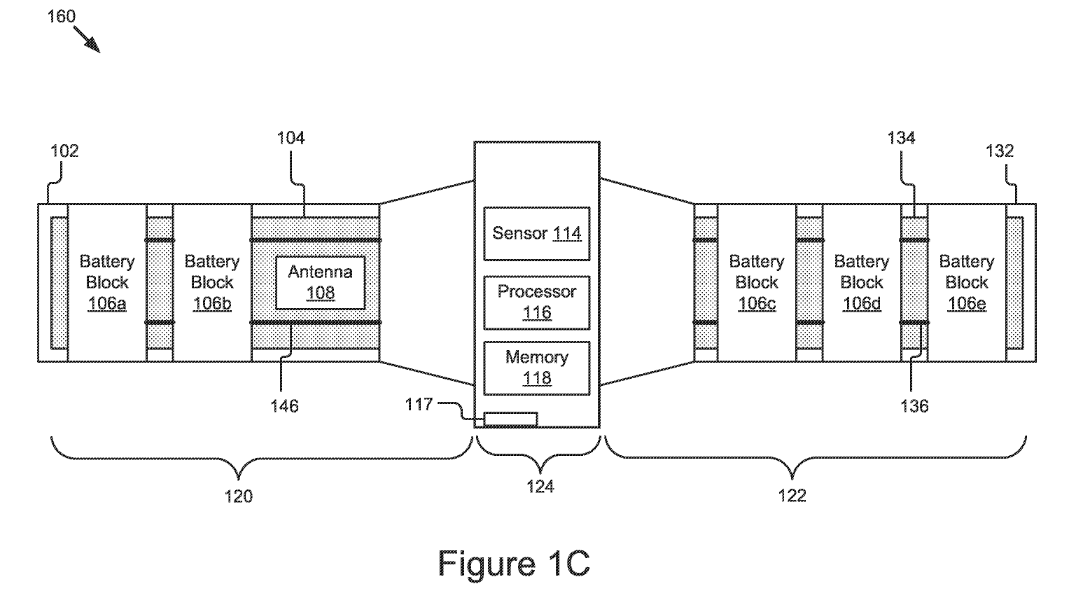

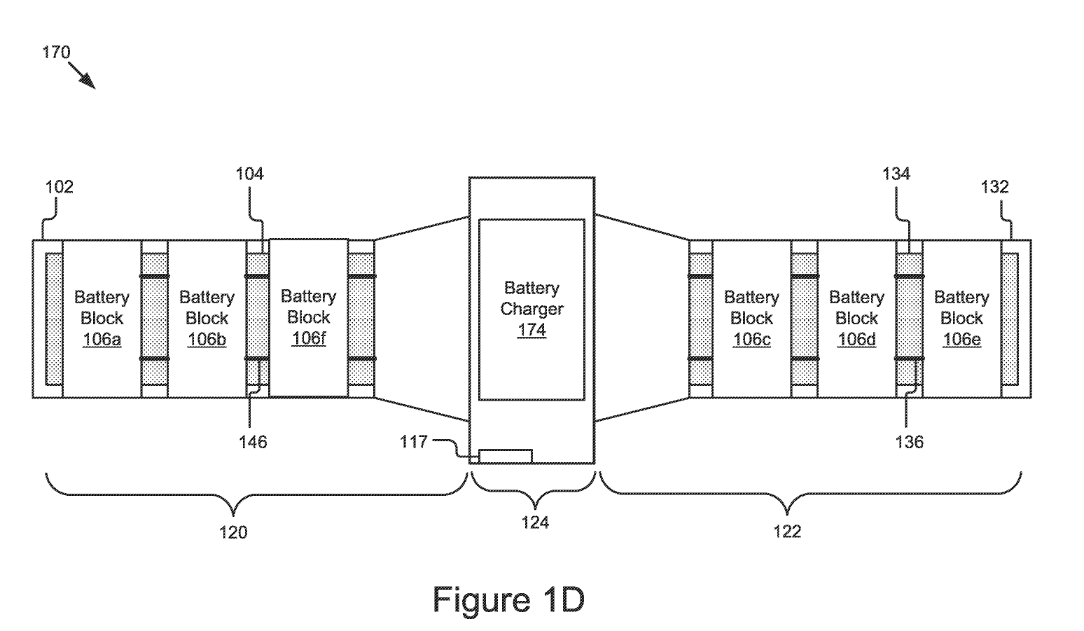

FIG. 1A illustrates an example wearable device 100 according to some embodiments. The wearable device 100 may include a first band portion 120, a second band portion 122, and a processing unit 124 placed between the first band portion 120 and the second band portion 122. In some embodiments, the processing unit 124 may be placed in the middle of the wearable device 100. The first band portion 120 and the second band portion 122 may have equal lengths. Alternatively, the processing unit 124 may not be placed in the middle of the wearable device 100, and a length of the first band portion 120 may not be equal to that of the second band portion 122.

In some embodiments, the processing unit 124 may include a display 112, a sensor 114, a processor 116, and a memory 118. The sensor 114, the processor 116, and the memory 118 are depicted using dashed lines in FIG. 1A to illustrate that the sensor 114, the processor 116, and the memory 118 may be disposed beneath the display 112. Although one sensor 114 is illustrated in FIG. 1A, the processing unit 124 may include one or more sensors 114.

In some embodiments, the display 112 may be a device configured to present visual information to a user. Examples of the display 112 may include, but are not limited to, a touch screen, a liquid-crystal display (LCD), a light-emitting diode (LED) display, and any other suitable display devices. In some embodiments, the display 112 may have a rectangular shape, a circular shape, an elliptical shape, or any other suitable geometric shape. In some embodiments, the display 112 may be capable of receiving inputs from a user. For example, the display 112 may be a touch screen that may detect user gestures performed on a surface of the display 112.

In some embodiments, the sensor 114 may be embedded beneath the display 112. The sensor 114 may include an accelerometer, a gyroscope, a magnetometer, a thermo sensor, a humidity sensor, a barometer, an air pressure sensor, a heart rate sensor, a pedometer, or any other suitable type of sensors. In some embodiments, the sensor 114 may be an integrated sensor that includes two or more different sensors integrated together. For example, the sensor 114 may be an integrated sensor that combines a three-dimensional (3D) accelerometer, a 3D gyroscope, and a 3D magnetometer.

The processor 116 may include, for example, a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. In some embodiments, the processor 116 may interpret and/or execute program instructions and/or process data stored in the associated memory 118. Although a single processor 116 is illustrated in FIG. 1A, the wearable device 100 may include multiple processors 116.

The memory 118 may include any suitable computer-readable media configured to retain program instructions and/or data for a period of time. By way of example, and not limitation, such computer-readable media may include tangible and/or non-transitory computer-readable storage media, including Random Access Memory (RAM), Read-Only Memory (ROM), Electrically Erasable Programmable Read-Only Memory (EEPROM), magnetic disk storage or other magnetic storage devices, flash memory devices (e.g., solid state memory devices), a specific molecular sequence (e.g., DNA or RNA), or any other storage medium which may be used to carry or store desired program code in the form of computer-executable instructions or data structures and which may be accessed by the processor 116. Combinations of the above may also be included within the scope of computer-readable media. Computer-executable instructions may include, for example, instructions and data that cause the processor 116 to perform a certain function or group of functions.

In some embodiments, the first band portion 120 may include a base band 102, a flexible PCB 104, battery blocks 106a and 106b, an antenna 108, and a speaker 110a. In some embodiments, the flexible PCB 104 may be disposed on top of the base band 102. In some embodiments, the battery blocks 106a, 106b and the antenna 108 may be disposed on top of the flexible PCB 104, respectively. In some embodiments, the speaker 110a may also be disposed on top of the flexible PCB 104. Alternatively, the speaker 110a may be disposed on top of the base band 102. Although two battery blocks 106a, 106b, one antenna 108, and one speaker 110a are illustrated, the first band portion 120 may include one or more battery blocks, one or more antennas, and one or more speakers.

In some embodiments, the first band portion 120 may also include a cover band (not illustrated in FIG. 1A) so that the flexible PCB 104, the batteries blocks 106a and 106b, and the antenna 108 may be embedded between the base band 102 and the cover band. The base band 102 and/or the cover band may be a plastic band, a rubber band, a leather band, and any other suitable type of bands that may act as a supporting structure in the wearable device 100. In some embodiments, the first band portion 120 may not include the base band 102. As a result, the battery blocks 106a, 106b and the antenna 108 may be interconnected by the flexible PCB 104 as illustrated in FIG. 1B.

In some embodiments, the flexible PCB 104 may include a circuitry that electrically interconnects elements of the first band portion 120. For example, the flexible PCB 104 may connect the battery blocks 106a and 106b using a series connection or a parallel connection. Alternatively or additionally, the flexible PCB 104 may connect to the processing unit 124 and may connect elements of the first band portion 120 to the processing unit 124. For example, the flexible PCB 104 may connect the antenna 108 to the processing unit 124 so that a signal received from the antenna 108 may be processed by the processor 116 of the processing unit 124. In another example, the flexible PCB 104 may connect the speaker 110a to the processing unit 124 so that the speaker 110a may receive an audio alert signal from the processor 116 and may play the audio alert signal to a user. In some embodiments, elements of the first band portion 120 may also be connected using wires 146.

In some embodiments, the second band portion 122 may include a base band 132, a flexible PCB 134, battery blocks 106c, 106d, 106e, and a speaker 110b. Although three battery blocks 106c, 106d, 106e and one speaker 110b are illustrated, the second band portion 122 may include one or more battery blocks and one or more speakers. Optionally, the second band portion 122 may include one or more antennas. The flexible PCB 134 may be disposed on top of the base band 132. The battery blocks 106c, 106d, and 106e may be disposed on top of the flexible PCB 134. In some embodiments, the speaker 110b may also be disposed on top of the flexible PCB 134.

In some embodiments, the second band portion 122 may also include a cover band (not illustrated in FIG. 1A) so that the flexible PCB 134 and the batteries blocks 106c, 106d, 106e may be embedded between the base band 132 and the cover band. The base band 132 and/or the cover band may be a plastic band, a metal band, a rubber band, a leather band, and any other suitable type of bands. In some embodiments, each of the base bands 102 and 132 may be part of the same base band. Alternatively, the base bands 102 and 132 may be different base bands connected to the processing unit 124, respectively. In some embodiments, the second band portion 122 may not include the base band 132. As a result, the battery blocks 106c, 106d, and 106e may be interconnected by the flexible PCB 134 as illustrated in FIG. 1B.

In some embodiments, the flexible PCB 134 may include a circuitry that electrically interconnects elements of the second band portion 122. For example, the flexible PCB 134 may connect the battery blocks 106c, 106d, and 106e using a series connection or a parallel connection. Alternatively or additionally, the flexible PCB 134 may connect to the processing unit 124 and may connect elements of the second band portion 122 to the processing unit 124. For example, the flexible PCB 134 may connect the speaker 110b to the processing unit 124 so that the speaker 110b may receive an audio alert signal from the processor 116 and may play the audio alert signal to a user. In some embodiments, elements of the second band portion 122 may also be connected using wires 136. In some embodiments, the PCBs 104 and 134 may be portions of the same PCB. Alternatively, the PCBs 104 and 134 may be different PCBs.

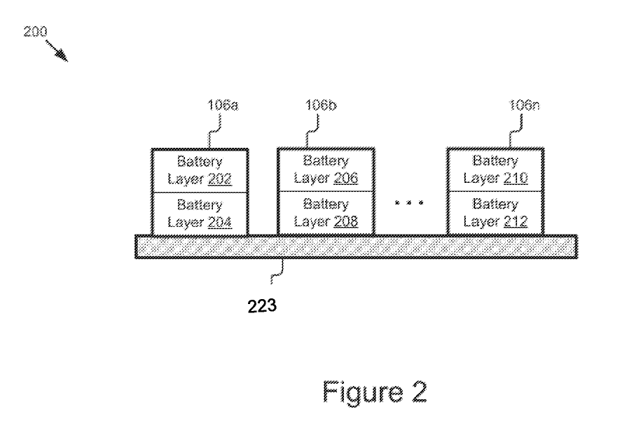

The battery blocks 106a, 106b, 106c, 106d, and 106e (referred to in the present disclosure individually and collectively as battery block 106) may supply power to the processing unit 124. Each battery block 106 may include one or more battery layers, and each battery layer may include a rechargeable battery (e.g., a thin film battery, a lithium battery) or an energy harvest device. The energy harvest device may be charged wirelessly. Alternatively or additionally, the energy harvest device may be charged by converting heat dissipated from a human body to energy. Alternatively or additionally, the energy harvest device may be charged by converting motion to energy and/or motion through the Earth's magnetic field to energy. The battery layers in each battery block 106 may be connected using a series connection or a parallel connection. Different battery blocks 106 in the wearable device 100 may also be connected using a series connection or a parallel connection. The battery block 106 is described below in more detail with reference to FIG. 2.

In some embodiments, each battery layer in the wearable device 100 may be charged by an external power source using a charging mechanism. Example charging mechanisms may include, but are not limited to, a wireless charging mechanism, a USB charging mechanism, a charging mechanism using a power adapter, a solar charging mechanism, a human body temperature charging mechanism, and any other suitable charging mechanism. The wearable device 100 may include a first charge port (e.g., a USB connector 117 illustrated in FIG. 1A or any other suitable port) so that the battery blocks 106 in the wearable device 100 may be charged by the external power source using the first charge port. For example, the battery blocks 106 may be charged by connecting the wearable device 100 to a computer using a USB cable via the USB connector 117. In some embodiments, the USB connector 117 may be used to transfer data between the wearable device 100 and an external client device.

In some embodiments, the battery blocks 106 may store power and may act as a power source that may provide power to the wearable device 100 and/or external devices. For example, the battery blocks 106 may be used to charge a smart phone using a charging mechanism such as a USB charging mechanism, a wireless charging mechanism, and any other suitable charging mechanism. The first charge port (e.g., the USB connector 117) may be used to charge the external devices. For example, the battery blocks 106 in the wearable device 100 may provide power to the external devices using the USB connector 117. Alternatively, the wearable device 100 may include a second charge port (e.g., another USB port) so that the battery blocks 106 in the wearable device 100 may provide power to the external devices using the second charge port.

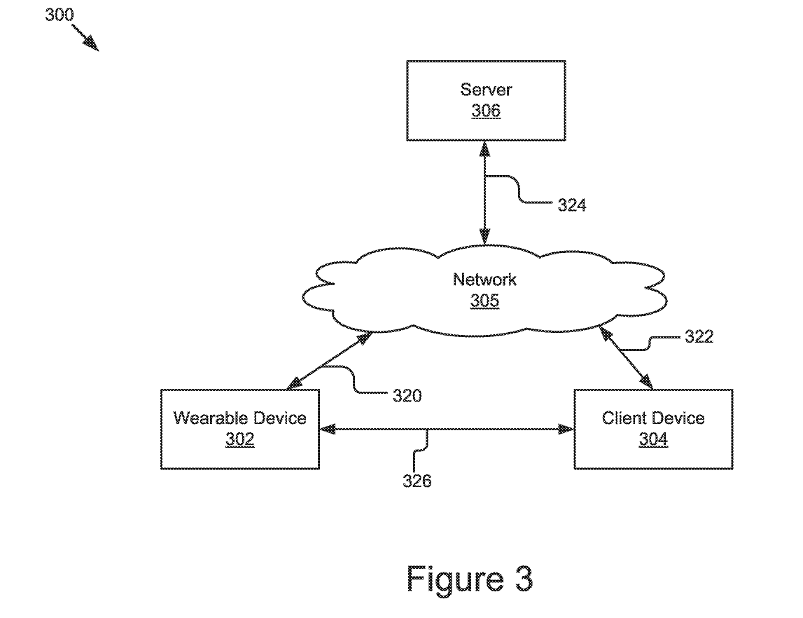

In some embodiments, the antenna 108 may be a flexible PCB radio frequency (RF) antenna. In these and other embodiments, the antenna 108 may provide any suitable form of wireless communication capability between the wearable device 100 and a client device (e.g., a client device 304 of FIG. 3). By way of example and not limitation, the antenna 108 may be configured to provide, via wireless mechanisms, LAN connectivity, Bluetooth connectivity, Wi-Fi connectivity, NFC connectivity, M2M connectivity, D2D connectivity, GSM connectivity, 3G connectivity, 4G connectivity, LTE connectivity, any other suitable communication capability, or any suitable combination thereof. In these and other embodiments, the antenna 108 may provide direct connectivity between the wearable device 100 and a client device.

The speakers 110a and 110b (referred to in the present disclosure individually and collectively as speaker 110) may have a rectangular shape, a circular shape, or any other suitable geometric shape. For example, the speaker 110 may have a length of 10 millimeters and a width between 3 millimeters and 5 millimeters. Although two speakers are illustrated in FIG. 1A, the wearable device 100 may include one or more speakers 110. The speakers 110 in the wearable device 100 may form stereo speakers.

In some embodiments, the speakers 110 may play audio alerts (e.g., audio messages, music, audio calendar reminders, etc.). For example, the wearable device 100 may receive a notification from a client device such as a smart phone via a wireless connection such as a Bluetooth connection or a Wi-Fi connection. In some embodiments, the wearable device 100 may send the notification to the speakers 110 so that the speakers 110 may play the notification in an audio format. In some embodiments, the speakers 110 may be included in the wearable device 100 so that a user does not need a headset or other audio reproduction devices to hear the audio alerts.

In some embodiments, the wearable device 100 may include an audio sensor 115 (e.g., a microphone). The audio sensor 115 may be placed at the processing unit 124. Alternatively, the audio sensor 115 may be disposed at any location of the wearable device 100. Although a single audio sensor 115 is illustrated in FIG. 1A, the wearable device 100 may include one or more audio sensors 115.

Modifications, additions, or omissions may be made to the example wearable device 100 without departing from the scope of the present disclosure. For example, in some embodiments, the example wearable device 100 may include any number of other components that may not be explicitly illustrated or described. For example, the wearable device 100 may include multiple processors 116. As another example, the wearable device 100 may include the wearable device 100 may include one or more speakers 110.

FIG. 1B illustrates another example wearable device 150 according to some embodiments. In some embodiments, the wearable device 150 of FIG. 1B and the wearable device 100 of FIG. 1A may include similar elements, and description for the similar elements will not be repeated here. Comparing to FIG. 1A, the antenna 108 in FIG. 1B may be extended on top of the battery blocks 106a and 106b to increase an area of the antenna 108 so that performance of the antenna 108 may be improved and a cost of the antenna 108 may be reduced. In some embodiments, a layer of insulation materials may be disposed between the battery blocks 106a, 106b and the antenna 108.

In some embodiments, the battery blocks 106 and the antenna 108 may be formed by flexible PCBs and may be combined together on the wearable device 150. As described above, the expansion of the antenna 108 over the battery blocks 106 may increase an area of the antenna 108, reduce a cost of the wearable device 150, and improve performance of the antenna 108. Meanwhile, in some embodiments, the battery blocks 106 with a series connection or a parallel connection may increase the power supply to the antenna 108.

Modifications, additions, or omissions may be made to the example wearable device 150 without departing from the scope of the present disclosure. For example, in some embodiments, the example wearable device 150 may include any number of other components that may not be explicitly illustrated or described. For example, the wearable device 150 may include multiple processors 116. As another example, the wearable device 150 may include the wearable device 100 may include one or more speakers 110.

FIG. 1C illustrates yet another example wearable device 160 according to some embodiments. The wearable device 160 of FIG. 1C and the wearable device 100 of FIG. 1A may include similar elements, and description for the similar elements will not be repeated here. Comparing to FIG. 1A, the wearable device 160 of the FIG. 1C does not include the display 112, the speakers 110, and the audio sensor 115. Modifications, additions, or omissions may be made to the example wearable device 160 without departing from the scope of the present disclosure. For example, in some embodiments, the example wearable device 160 may include any number of other components that may not be explicitly illustrated or described.

FIG. 1D illustrates yet another example wearable device 170 according to some embodiments. The wearable device 170 of FIG. 1D and the wearable device 100 of FIG. 1A may include similar elements, and description for the similar elements will not be repeated here. Comparing to FIG. 1A, the wearable device 170 of the FIG. 1D does not include the display 112, the speakers 110, and the audio sensor 115. The wearable device 170 includes battery blocks 106a-106f and a battery charger 174. The battery charger 174 may include a rechargeable battery. The battery blocks 106a-106f and the battery charger 174 may form an overall battery that may act as a power source for charging external devices such as a smart phone, a music player, and any other portable devices. The USB connector 117 may be used by the wearable device 170 to charge the external devices. In some embodiments, the wearable device 170 may include a processor, a memory, one or more sensors, and any other suitable elements. Modifications, additions, or omissions may be made to the example wearable device 170 without departing from the scope of the present disclosure. For example, in some embodiments, the example wearable device 170 may include any number of other components that may not be explicitly illustrated or described.

FIG. 2 illustrates a block diagram 200 of example battery blocks 106 in a wearable device according to some embodiments. The wearable device may include battery blocks 106a, 106b . . . 106n disposed on top of a flexible PCB 223 of the wearable device. The battery block 106a may include battery layers 202 and 204. The battery block 106b may include battery layers 206 and 208. The battery block 106n may include battery layers 210 and 212. Although two battery layers are illustrated for each battery block in FIG. 2, each of the battery blocks 106a, 106b . . . 106n may include one or more battery layers.

In some embodiments, a battery layer may include a thin film battery, a lithium battery, and any other suitable type of rechargeable batteries. For example, a battery layer may include a thin film rechargeable lithium battery. In some embodiments, battery layers in a particular battery block may be coupled using a series connection to increase a voltage of the particular battery block. Alternatively, in some embodiments, the battery layers in the particular battery block may be coupled using a parallel connection to increase a current of the particular battery block. In some embodiments, different battery blocks in the wearable device may be coupled using a series connection to increase a voltage of an overall battery formed by the battery blocks. Alternatively, in some embodiments, different battery blocks in the wearable device may be coupled using a parallel connection to increase a current of the overall battery formed by the battery blocks. By increasing the voltage and/or current of the overall battery formed by the different battery blocks in the wearable device, an operational life of the battery blocks may be extended.

For example, assume that each of the battery layers 202, 204, 206, 208, 210, and 212 may have a current of 5 milliampere (mA) and a voltage of 1.5 volts (V). In some embodiments, the battery layers 202 and 204 of the battery block 106a may be coupled using a parallel connection so that the battery block 106a may have a voltage of 1.5 V and a current of 5×2=10 mA. Similarly, the battery layers 206 and 208 of the battery block 106b may be coupled using a parallel connection so that the battery block 106b may have a voltage of 1.5 V and a current of 5×2=10 mA. In some embodiments, the battery layers 210 and 212 of the battery block 106n may be coupled using a parallel connection so that the battery block 106n may have a voltage of 1.5 V and a current of 5×2=10 mA. In some embodiments, the battery blocks 106a, 106b . . . 106n may be coupled using a series connection to form an overall battery with a voltage of 1.5×N V and a current of 10 mA, where the symbol “N” may represent a number of battery blocks in the wearable device. Alternatively, in some embodiments, the battery blocks 106a, 106b . . . 106n may be coupled using a parallel connection to form an overall battery with a current of 10×N mA and a voltage of 1.5V.

By using a series connection and/or a parallel connection to connect different battery layers in each battery block and to connect the different battery blocks 106a, 106b . . . 106n to form an overall battery, battery capacity for the wearable device may be increased and an operational life of the overall battery may be extended.

FIG. 3 illustrates an example communication system 300 that includes a wearable device according to some embodiments. In some embodiments, the system 300 may include a wearable device 302, a client device 304, and a server 306. In some embodiments, the entities of the system 300 may be coupled with a network 305. For example, the wearable device 302 may be coupled with the network 305 via a signal line 320, the client device 304 may be coupled with the network 305 via a signal line 322, and the server 306 may be coupled with the network 305 via a signal line 324. In some embodiments, the wearable device 302 may be coupled with the client device 304 via a signal line 326 and may access the network 305 via the client device 304. Each of the signal lines 320, 322, 324, and 326 may represent a wired connection or a wireless connection.

In some embodiments, the network 305 can be a conventional type, wired or wireless, and may have numerous different configurations including a star configuration, token ring configuration, or other configurations. Furthermore, the network 305 may include a local area network (LAN), a wide area network (WAN) (e.g., the Internet), or other interconnected data paths across which multiple devices may communicate. In some embodiments, the network 305 may be a peer-to-peer network. In some embodiments, the network 305 may also be coupled with or includes portions of a telecommunications network for sending data in a variety of different communication protocols. In some embodiments, the network 305 includes Bluetooth® communication networks or a cellular communications network for sending and receiving data including via short messaging service (SMS), multimedia messaging service (MMS), hypertext transfer protocol (HTTP), direct data connection, WAP, e-mail, etc. In some embodiments, the network 305 may include a global positioning system (GPS) satellite for providing GPS navigation to the client device 304 and/or the wearable device 302. In some embodiments, the network 305 may be a mobile data network such as third-generation (3G), fourth-generation (4G), long-term evolution (LTE), Voice-over-LTE (“VoLTE”) or any other mobile data network or combination of mobile data networks.

The client device 304 may be a computing device that includes a memory and a processor, for example, a laptop computer, a desktop computer, a tablet computer, a mobile telephone, a personal digital assistant (“PDA”), a mobile e-mail device, a portable game player, a portable music player, a television with one or more processors embedded tin the present disclosure or coupled thereto, or another electronic device capable of accessing the network 305.

In some embodiments, the server 306 may be a hardware server that includes a processor, a memory, and network communication capabilities. In some embodiments, the server 306 may send and receive data to and from other entities of the system 300 via the network 305. In some embodiments, the server 306 may provide various services to the client device 304 and/or the wearable device 302. For example, the server 306 may provide one or more of navigation service, weather updates, time updates, calendar updates, email updates, phone call updates, social network updates, and any other suitable services to the client device 304 and/or the wearable device 302.

Modifications, additions, or omissions may be made to the example communication system 300 without departing from the scope of the present disclosure. For example, in some embodiments, the example communication system may include any number of other components that may not be explicitly illustrated or described. For example, the communication system 300 may include multiple wearable devices 302 and/or client devices 304.

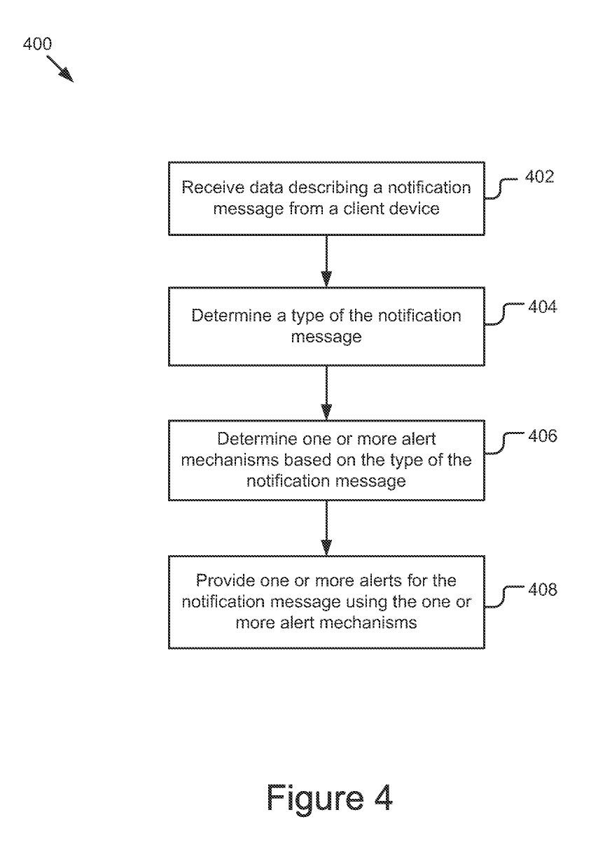

FIG. 4 is a flow chart that illustrates an example method 400 of providing alerts using a wearable device according to some embodiments. Although illustrated as discrete blocks, various blocks may be divided into additional blocks, combined into fewer blocks, or eliminated, depending on the desired implementation. The method 400 may be performed by and is explained in context of the system 300 of FIG. 3. Other systems or apparatuses may perform the method 400.

In some embodiments, a wearable device may receive 402 data describing a notification message from a client device. For example, the wearable device may receive a notification message from a smart phone. In some embodiments, the wearable device may determine 404 a type of the notification message. For example, the wearable device may determine whether the notification message is related to a phone call, an email, a calendar update, or any other type of notification messages. In some embodiments, the wearable device may determine 406 one or more alert mechanisms based on the type of the notification message. In some embodiments, the one or more alert mechanisms may include presenting the notification message visually on a display of the wearable device, playing the notification message using a speaker of the wearable device, causing the wearable device to vibrate, and/or any other suitable alert mechanisms. In some embodiments, the wearable device may provide 408 the one or more alerts for the notification message using the one or more alert mechanisms. For example, the wearable device may present a visual icon on the display and/or may play an alert sound using the speaker.

One skilled in the art will appreciate that, for the method 400 and other processes and methods disclosed in the present disclosure, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

As described above, the embodiments described in the present disclosure may include the use of a special-purpose or general-purpose computer (e.g., the processor 116 of FIGS. 1A and 1B) including various computer hardware or software modules, as discussed in greater detail below. The special-purpose or general-purpose computer may be configured to execute computer-executable instructions stored on computer-readable media (e.g., the memory 118 of FIGS. 1A and 1B).

Computer-executable instructions may include, for example, instructions and data which cause a general-purpose computer, special-purpose computer, or special-purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in the present disclosure, the terms “module” or “component” may refer to specific hardware implementations configured to perform the operations of the module or component and/or software objects or software routines that may be stored on and/or executed by general-purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general-purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the present disclosure.

What is claimed is:

1. A wearable device comprising:
a flexible printed circuit board;
a processing unit coupled with the flexible printed circuit board, the processing unit including a display device;
one or more battery blocks mounted on the flexible printed circuit board, the one or more battery blocks configured to supply power to the processing unit; and
an antenna mounted on the flexible printed circuit board and communicatively coupled with the processing unit.

2. The wearable device of claim 1, further comprising one or more speakers connected to the processing unit.

3. The wearable device of claim 1, wherein the one or more battery blocks are coupled using one of a series connection and a parallel connection.

4. The wearable device of claim 1, wherein each of the one or more battery blocks includes one or more battery layers.

5. The wearable device of claim 4, wherein the one or more battery layers includes one or more thin film batteries, one or more lithium batteries, and one or more sodium-ion batteries.

6. The wearable device of claim 4, wherein the one or more battery layers are coupled using one of a series connection and a parallel connection.

7. The wearable device of claim 1, wherein the processing unit further includes a sensor, a processor, and a memory.

8. The wearable device of claim 7, wherein the sensor includes one of an accelerometer, a gyroscope, a magnetometer, a temperature sensor, a humidity sensor, an air pressure sensor, a barometer, and a heartbeat sensor.

9. The wearable device of claim 1, wherein the one or more battery blocks are configured to be charged by an external power source using one of a wireless charging mechanism, a universal serial bus charging mechanism, a solar charging mechanism, a charging mechanism using a power adapter, and a human body temperature charging mechanism.

10. The wearable device of claim 1, wherein the one or more battery blocks are configured to charge a client device using one of a wireless charging mechanism and a universal serial bus charging mechanism.

11. The wearable device of claim 1, further comprising a universal serial bus connector used to charge the one or more battery blocks by an external power source.

12. The wearable device of claim 11, wherein the one or more battery blocks are configured to charge a client device using the same universal serial bus connector.

13. The wearable device of claim 1, further comprising a microphone.

14. The wearable device of claim 1, wherein the antenna is flexible and disposed over the one or more battery blocks.

15. A wearable device comprising:
a flexible printed circuit board;
a processing unit coupled with the flexible printed circuit board, the processing unit including a processor, a memory, and a sensor;
one or more battery blocks mounted on the flexible printed circuit board, the one or more battery blocks configured to supply power to the processing unit; and
an antenna mounted on the flexible printed circuit board and communicatively coupled with the processing unit.

16. The wearable device of claim 15, further comprising a universal serial bus connector used for charging the one or more battery blocks in the wearable device by an external power source and for data transfer between the wearable device and a client device.

17. The wearable device of claim 16, wherein the one or more battery blocks are configured to charge a client device using the universal serial bus connector.

18. A wearable device comprising:
a flexible printed circuit board;
a processing unit coupled with the flexible printed circuit board, the processing unit including a battery charger;
one or more battery blocks mounted on the flexible printed circuit board, wherein the battery charger and the one or more battery blocks act as a power source for charging a client device; and
a charge port configured to output power to charge the client device.

19. The wearable device of claim 18, wherein the charge port includes a universal serial bus connector.

20. The wearable device of claim 19, wherein the universal serial bus connector is used for charging the one or more battery blocks and the battery charger in the wearable device by an external power source.
